(19) United States
(12) Patent Application Publication
(10) Pub. No.: US 2026/0292612 A1
(43) Pub. Date: Sep. 24, 2026

(54) Configuring a User Equipment to Perform Measurement Reporting

(71) Applicant: Telefonaktiebolaget LM Ericsson (publ), Stockholm (SE)

(72) Inventors: Icaro Leonardo Da Silva, Solna (SE); Antonino Orsino, Kirkkonummi (FI); Claes Tidestav, Bålsta (SE)

(21) Appl. No.: 19/475,899

(22) PCT Filed: May 13, 2024
(86) PCT No.: PCT/SE2024/050452

§ 371 Date: Oct. 16, 2025

Related U.S. Application Data
(60) Provisional application No. 63/501,781, filed on May 12, 2023.

(51) Int. Cl. H04W 36/00

(52) U.S. Cl. CPC H04W 36/0058

(57) ABSTRACT

In an example, a method in a User Equipment (UE) for configuring the UE to perform measurement reporting is provided The method comprises receiving a measurement reporting configuration, wherein the measurement reporting configuration is associated with a resource configuration, and the resource configuration is associated with one or more L1/L2-triggered mobility (LTM) candidate cells. The method also comprises reporting one or more measurements performed on the one or more associated LTM candidate cell.

### TECHNICAL FIELD

Examples of this disclosure relate to configuring a User Equipment (UE) to perform measurement reporting, for example on one or more L1/L2-triggered mobility (LTM) candidate cells.

### BACKGROUND

In 5G New Radio (NR), to support beam management operation, a UE is configured by the network with a Channel State Information (CSI) measurement configuration, e.g. Information Element (IE) CSI-MeasConfig received within an RRCReconfiguration message. This is configured per serving cell (within ServingCellConfig e.g. of an SpCell) in which CSI reports are to be transmitted. The signaling is defined in 3GPP TS 38.331 v15.17.0.

For each CSI report the UE needs to transmit, the UE receives from the network an instance of a CSI reporting configuration (IE CSI-ReportConfig) including a pointer to a resource configuration ID (CSI-ReportConfigld) and a parameter ‘carrier’ which indicates the serving cell configuration in which the UE needs to find the resource configured by that resource configuration ID. The CSI_ReportConfig IE is shown below:

| | |
|---|---|
| CSI-ReportConfig : := | SEQUENCE { |
| reportConfigId | CSI-ReportConfigId, |
| carrier | ServCellIndex |
| OPTIONAL, -- Need S | |
| ... | |
| csi-IM-ResourcesForInterference | CSI-ResourceConfigId |
| OPTIONAL, -- Need R | |
| ... | |
| } | |

Within the serving cell configuration indicated by the parameter ‘carrier’, the UE receives an explicit list of CSI resources (also called CSI resource configuration(s)), comprising a list of Channel State Information-Reference Signal (CSI-RS) sets (nzp-CSI-RS-ResourceSetList, IE SEQUENCE (SIZE (1 . . . maxNrofNZP-CSI-RS-ResourceSetsPerConfig)) OF NZP-CSI-RS-ResourceSetld) and/or SSBs sets (csi-SSB-ResourceSetList, IE SEQUENCE (SIZE (1 . . . maxNrofCSI-SSB-ResourceSetsPerConfig)) OF CSI-SSB-ResourceSetld) for a given serving cell the UE is configured with, e.g. the SpCell of a cell group, or an SCell.

An instance of a reporting configuration, associated to a given report (i.e. an instance of the IE CSI-ReportConfig), is included in the serving cell configuration (ServingCellConfig) in which such a report is meant to be transmitted. In other words, if the UE is configured with a number of serving cells associated to ServingCellConfig(1), ServingCellConfig(2), ServingCellConfig(3) and the UE receives a CSI-ReportConfig(k) within ServingCellConfig(2) (i.e. within the CSI-MeasConfig of ServingCellConfig(2)), this indicates to the UE that CSI reports associated to CSI-ReportConfig(k) are to be transmitted by the serving cell with ServingCellConfig(2).

In a Central Unit (CU)/Distributed Unit (DU) split architecture, all the serving cells the UE is configured with are associated to the same DU, which is called a Serving DU (or Source DU), denoted by S-DU.

In Release 18 (Rel-18), 3GPP has agreed on a Work Item (WI) on Further New Radio (NR) mobility enhancements, in particular, in a technical area entitled L1/L2 based inter-cell mobility. See MediaTek, “New WID on Further NR mobility enhancements,” 3GPP TSG RAN Meeting #94e, RP-213565, e-Meeting, Dec. 6-17, 2021 for further details. According to this Work Item Description (WID), when the UE moves from the coverage area of one cell to another cell, at some point a serving cell change needs to be performed. Currently serving cell change is triggered by L3 measurements and is done by RRC signalling triggered Reconfiguration with Synchronisation for change of PCell and PSCell, as well as release or add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signalling, in order to reduce the latency, overhead and interruption time.

FIG. 1 shows an example of a process for LTM configuration and LTM cell switch in inter-DU scenarios. The process includes the following steps:
1. The UE sends a MeasurementReport message (L3 measurement result FFS) to the source gNB-DU containing measurements of neighboring cells. The source gNB-DU sends an UL RRC MESSAGE TRANSFER message conveying the received MeasurementReport message to the gNB-CU.
2. The gNB-CU determines to initiate L1/L2 triggered mobility configuration.
3. The gNB-CU sends a UE CONTEXT SETUP REQUEST message to the candidate gNB-DU, containing the target candidate cells. Either a single or multiple UE Context Setup procedure(s) should be used.
4. If the candidate gNB-DU accepts the request of LTM configuration, it responds to the gNB-CU with a UE CONTEXT SETUP RESPONSE message including the generated lower layer RRC configuration for the accepted target candidate cell(s).
5. The gNB-CU sends a DL RRC MESSAGE TRANSFER message to the source gNB-DU, which includes the generated RRCReconfiguration message with the L1/L2 triggered mobility configuration.
6. The source gNB-DU forwards the received RRCReconfiguration message to the UE.
7. The UE responds to the source gNB-DU with an RRCReconfigurationComplete message.
8. The source gNB-DU forwards the RRCReconfigurationComplete message to the gNB-CU via an UL RRC MESSAGE TRANSFER message.
9. The UE sends the lower layer measurement result to the source gNB-DU.
10. The source gNB-DU decides to execute L1/L2 triggered mobility to a candidate target cell.
11. The source gNB-DU sends LTM command to the UE.
   Editor's note: The LTM command needs to be updated according to RAN2's discussion.
12. The source gNB-DU, in a new message or a legacy message, signals the gNB-CU about the initiation of the L1/L2 triggered mobility command to the UE including the Target cell ID.
13. The target gNB-DU detects UE access.
14. The target gNB-DU sends the ACCESS SUCCESS message to the gNB-CU with the target cell ID.
15. For inter-DU L1/L2 Triggered Mobility, whether and how to release the source cell/prepared cells' resources in the source gNB-DU is currently unspecified.

As shown in FIG. 1, it is envisioned that for LTM, a UE sends the lower layer measurement result to the source gNB-DU (also referred to herein as S-DU). The UE needs to be configured to perform these measurements. In RAN2#121bis meeting, the following has been agreed regarding these lower layer measurements, in particular how they would be configured:
The location of RS configuration for SSB-based measurements of candidate cells is external to the ServingCellConfig(s) of current serving cells and external to the configuration of the LTM candidate cells. The RS configuration, per RAN1 agreement, can include PCI or logical ID, SMTC location, frequency location, and SCS.
RAN2 assumes that the location of configurations of TCI states for the candidate cells (used before/at cell switch) is external to the ServingCellConfig(s) of current serving cells and external to the configuration of the LTM candidate cells (same location as RS configuration).
RAN2 assumes that For L1 measurements of LTM candidate cells, the reporting configuration is placed inside the ServingCellConfig of current serving cell(s).
RAN2 assumes that whether filtering, hysteresis, and time-to-trigger are needed for LTM specific L1 measurements is up to RAN1.
Whether to assume L1/L2 signaling to control or change L1 measurement/reporting for LTM needs further discussion (parts may be discussed in RAN1). RAN2 assumes that such control would be limited to certain aspect that need frequent update and restricted by RRC configuration.

In addition, RAN1 has previously agreed as detailed in the following documents: R1-2302256, “Final Report of 3GPP TSG RAN WG1 #112 v1.0.0,” ETSI MCC, 3GPP TSG RAN WG1 Meeting #112bis-e; R1-2300001, “Final Report of 3GPP TSG RAN WG1 #111 v1.0.0,” ETSI MCC, 3GPP TSG RAN WG1 Meeting #112; and R1-2210801, “Final Report of 3GPP TSG RAN WG1 #110bis-e v1.0.0,” ETSI MCC, 3GPP TSG RAN WG1 Meeting #111.

### SUMMARY

The problem addressed by examples of this disclosure may be how the UE is configured to perform lower layer measurements on LTM candidate cell(s) and how the UE is instructed to report these measurements. In particular, how a CSI reporting configuration (e.g. a CSI-ReportConfig instance for LTM) is associated to resource configuration(s) associated to LTM candidate cell(s).

Examples of this disclosure may also address the problem of determining which nodes in a CU/DU split architecture is responsible for generating the configuration(s) necessary to enable the UE to perform the measurements on LTM candidate cell(s) and to determine which measurements are associated to which CSI reporting configuration instance.

Certain embodiments may provide one or more of the following technical advantage(s). For example, it may be possible to provide information about which measurement resources in which candidate cells the UE should use to perform measurements. The measurement resources may be described with a large degree of flexibility. For example, the frequency location of the measurement resources can be specified. At the same time, the description may be resource efficient, to limit the signaling overhead when configuring the UE.

Furthermore, examples of this disclosure may specify how the UE would report the measurements to the network, and may provide a flexible while still resource efficient way to configure the UE with this information. Additionally, examples of this disclosure may specify how this configuration information can be sent between network nodes, such as a candidate distributed unit (C-DU) and a serving distributed unit (S-DU) to enable the signaling of the configuration to the UE. The inter-node signaling may for example reuse existing signaling methods to the extent possible, to maximize reuse of current implementations.

One aspect of this disclosure provides a method in a User Equipment (UE) for configuring the UE to perform measurement reporting. The method comprises receiving a measurement reporting configuration, wherein the measurement reporting configuration is associated with a resource configuration, and the resource configuration is associated with one or more L1/L2-triggered mobility (LTM) candidate cells. The method also comprises reporting one or more measurements performed on the one or more associated LTM candidate cells.

Another aspect of this disclosure provides a method performed by a first network node for configuring a User Equipment (UE) for measurement reporting. The method comprises sending, to the UE, a measurement reporting configuration. The measurement reporting configuration is associated with a resource configuration, and the resource configuration is associated with one or more L1/L2-triggered mobility (LTM) candidate cells for the UE.

A further aspect of this disclosure provides apparatus in a User Equipment (UE) for configuring the UE to perform measurement reporting. The apparatus comprises a processor and a memory. The memory contains instructions executable by the processor such that the apparatus is operable to receive a measurement reporting configuration, wherein the measurement reporting configuration is associated with a resource configuration and the resource configuration is associated with one or more L1/L2-triggered mobility (LTM) candidate cells, and report one or more measurements performed on the one or more associated LTM candidate cells.

A still further aspect of this disclosure provides apparatus in a first network node for configuring a User Equipment (UE) for measurement reporting. The apparatus comprises a processor and a memory. The memory contains instructions executable by the processor such that the apparatus is operable to send, to the UE, a measurement reporting configuration, wherein the measurement reporting configuration is associated with a resource configuration, and the resource configuration is associated with one or more L1/L2-triggered mobility (LTM) candidate cells for the UE.

Another aspect of this disclosure provides apparatus in a User Equipment (UE) for configuring the UE to perform measurement reporting. The apparatus is configured to receive a measurement reporting configuration, wherein the measurement reporting configuration is associated with a resource configuration and the resource configuration is associated with one or more L1/L2-triggered mobility (LTM) candidate cells, and report one or more measurements performed on the one or more associated LTM candidate cells.

An additional aspect of the present disclosure provides apparatus in a first network node for configuring a User Equipment (UE) for measurement reporting. The apparatus is configured to send, to the UE, a measurement reporting configuration, wherein the measurement reporting configuration is associated with a resource configuration, and the resource configuration is associated with one or more L1/L2-triggered mobility (LTM) candidate cells for the UE.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows an example of a process for LTM configuration and LTM cell switch in inter-DU scenarios;

FIG. 2 is a flow chart illustrating a method in accordance with some embodiments;

FIG. 3 is a flow chart illustrating a method in accordance with some embodiments;

FIG. 4 illustrates an example of an overall architecture with both NG-RAN and 5GC;

FIG. 5 illustrates an example deployment of a logical gNB/en-gNB;

FIG. 6 illustrates an example of an overall architecture for separation of gNB-CU-CP and gNB-CU-UP;

FIG. 7 illustrates an example of a signaling flow in methods according to embodiments of this disclosure;

FIG. 8 shows an example of a communication system in accordance with some embodiments;

FIG. 9 shows a UE in accordance with some embodiments;

FIG. 10 shows a network node in accordance with some embodiments;

FIG. 11 is a block diagram of a host;

FIG. 12 is a block diagram illustrating a virtualization environment in which functions implemented by some embodiments may be virtualized; and

FIG. 13 shows a communication diagram of a host communicating via a network node with a UE over a partially wireless connection in accordance with some embodiments.

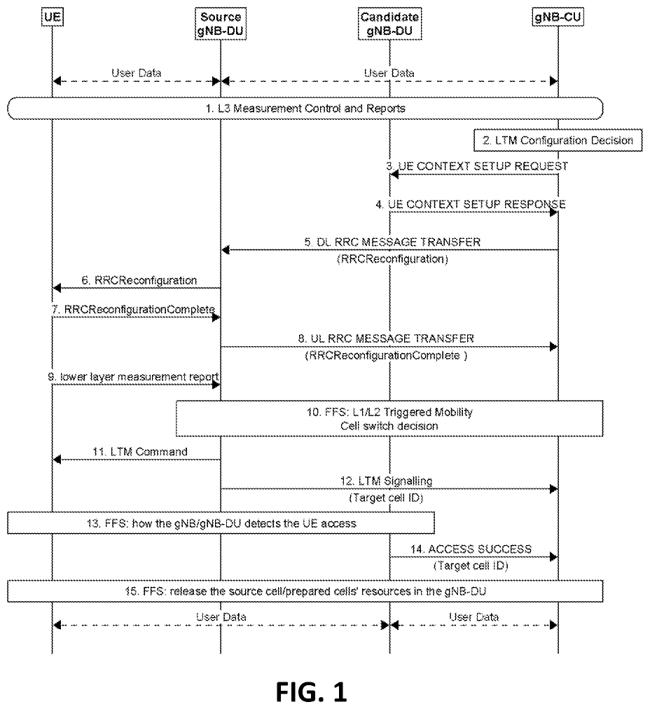

### DETAILED DESCRIPTION

Some of the embodiments contemplated herein will now be described more fully with reference to the accompanying drawings. Embodiments are provided by way of example to convey the scope of the subject matter to those skilled in the art.

One or more examples of this disclosure refers to the term “L1/L2 based inter-cell mobility” as used in the Work Item Description in 3GPP, though this disclosure interchangeably also uses the terms L1/L2 mobility, L1-mobility, L1 based mobility, L1/L2-centric inter-cell mobility, L1/L2 inter-cell mobility L1/L2-Triggered Mobility, Lower-layer triggered Mobility or LTM. The basic principle in some examples is that the UE receives a lower layer signaling from the network indicating to the UE a change (or switch or activation) of its serving cell (e.g. change of PCell, from a source to a target PCell), wherein a lower layer signaling is a message/signaling of a lower layer protocol, which may be referred as a L1/L2 inter-cell mobility execution command or LTM cell switch command. The change of serving cell (e.g. change of PCell) may also lead to a change in Scell(s) for the same cell group e.g. in case the command triggers the UE to change to another cell group configuration of the same type (e.g. another MCG configuration). Before the UE receives the LTM cell switch command, the UE is configured by the network with one or more LTM candidate cell configurations (e.g. reception of an RRC Reconfiguration message, with at least one LTM candidate cell configuration) A LTM candidate cell configuration may include parameters in the IE CellGroupConfig for an LTM candidate cell and/or an embedded RRC Reconfiguration for an LTM candidate cell.

The term LTM cell switch procedure refers to the process of a UE switching (or changing) its cell from a source cell to a target cell (which may be called here an LTM candidate cell or a neighbour cell), using L1/L2-triggered mobility (LTM). In the context of L1/L2-triggered mobility (LTM), an LTM cell switch procedure may sometimes also be known as L1/L2 based inter-cell mobility execution, LTM execution, dynamic switch, LTM switch, (LTM) cell switch, (LTM) serving cell change or (LTM) cell change. In the context of examples of this disclosure, switching to the LTM candidate cell configuration comprises the UE considering that an LTM candidate cell becomes its new special cell (SpCell) e.g. PCell in case of LTM being configured for a Master Cell Group (MCG) and/or PSCell in case of LTM being configured for a Secondary Cell Group (SCG); or, changing its SpCell from the current PCell to an LTM candidate cell.

Even if the term switch or change of cells is used, this may comprise a switch or change of a whole cell group configuration, which includes a change in the SpCell (e.g. change of PCell, or change of PSCell), a change in SCells of the cell group (e.g., addition, modification and/or release of one or more SCells) or a swap between SpCell and SCell roles for two cells (e.g. as result of the switch or change, a first cell which was SpCell becomes an SCell and a second cell that was an SCell becomes the new SpCell).

One or more examples of this disclosure refers to a LTM candidate cell, which is a cell the UE is configured with when configured with L1/L2-triggered mobility. That is a cell the UE can move to in a LTM cell switch procedure, upon reception of a LTM cell switch command. Such cells may also be called candidate cell(s), candidates, mobility candidates, non-serving cells, additional cells, target candidate cell, target candidate, etc. A LTM candidate cell is a cell the UE may perform measurements on (e.g., CSI measurements) so that the UE reports these measurements and network may take educated decision on which beam (e.g. TCI state) and/or cell the UE is to be switched to. An LTM candidate cell may be a candidate to be a target PCell or PSCell, or an SCell of a cell group (e.g., MCG SCell or a SCG SCell).

One or more examples of this disclosure refers to at least one LTM candidate cell configuration and that the UE has received at least one LTM candidate cell configuration. This is also sometimes referred to as a configuration of a LTM candidate cell, and may in some examples be an RRC configuration, such as encapsulated in an RRC Reconfiguration message, that the UE receives when being configured with L1/L2-Triggered Mobility. A LTM candidate cell configuration in some examples comprises the configuration which the UE needs to start to operate accordingly when it performs an LTM cell switch procedure to that LTM candidate cell e.g. upon reception of the LTM cell switch command to that LTM candidate cell, which becomes the target cell and the current (new) SpCell, or an SCell in a serving frequency. The LTM candidate cell configuration in some examples comprises parameters of a serving cell (or multiple serving cells, such as a cell group and/or configuration(s) included in a CellGroupConfig IE), comprising one or more of the groups of parameters, such as an RRCReconfiguration message an IE CellGroupConfig or an IE SpCellConfig (or the IE SCellConfig, in the case of a Secondary Cell). A LTM candidate cell configuration may in one example comprise one or more of: i) the PCell configuration and one or more SCell configuration(s) of a Master Cell Group (MCG); i) the PSCell configuration and one or more SCell configuration(s) of a secondary Cell Group (SCG). The terms (LTM) candidate configuration, LTM configuration, (LTM) candidate target cell configuration, (LTM) target candidate (cell) configuration may be used interchangeably when referring to LTM candidate cell configuration.

The actual LTM candidate cell configuration and its exact content and/or structure of this IE and/or embedded message may in some examples be called an RRC model for the candidate configuration, or simply RRC model. An LTM candidate cell configuration in some examples comprises the configuration which the UE needs to operate accordingly when it performs (executes) L1/L2 based inter-cell mobility execution to a LTM candidate cell, upon reception of the lower layer signaling (MAC CE) indicating a L1/L2 based inter-cell mobility to a LTM candidate cell (which becomes the target cell and the current (new) PCell, or an SCell in a serving frequency), or upon reception of the lower layer signaling (MAC CE) indicating a L1/L2 based inter-cell mobility to a LTM candidate cell configuration indicated with a candidate configuration identifier, identity or index (sometimes also denoted candidate configuration ID). The UE may be configured with multiple LTM candidate cell configurations, so a Candidate DU (C-DU) generates and sends to the CU multiple configuration(s). The actual LTM candidate cell configuration the UE receives during the LTM configuration may be a delta signaling to be applied on top of a reference configuration, so that the actual configuration the UE is to use in the LTM candidate cell upon LTM cell switch is the combination of the LTM candidate cell configuration and the reference configuration (e.g. separately signaled by the network to the UE). That combination of the LTM candidate cell configuration and the reference configuration the UE uses may also be called a complete LTM candidate cell configuration. For the context of examples of this disclosure, unless stated otherwise, this complete LTM candidate cell configuration may also be considered as an LTM candidate cell configuration.

One or more examples of this disclosure refers to serving cell. A serving cell is a cell configured for the UE for example an SpCell, PCell, PSCell or SCell.

One or more examples of this disclosure refers to an LTM candidate cell, which is a cell the UE is configured with which may become an SpCell, PCell, PSCell or SCell.

One or more examples of this disclosure refers to source cell and target cell. A source cell is a cell configured as a serving cell for the UE prior to the execution of the LTM cell switch procedure. A target cell is a cell configured as a serving cell, for example an SpCell, PCell, PSCell or SCell, for the UE after, or as a result of, the execution of the LTM cell switch procedure, which may include a cell indicated in the LTM cell switch command indicating to the UE the LTM cell switch procedure or a cell configured as result of the UE switching to the LTM candidate cell configuration provided by an indication of an LTM candidate cell configuration, also sometimes known as a candidate configuration index, an LTM configuration index or an LTM candidate cell index, in the LTM cell switch command. In the context of a LTM cell switch procedure executed by the UE, given cell may be either a source cell, a target cell, both a source cell and target cell or neither a source cell nor a target cell.

One or more examples of this disclosure refers to source configuration, which may be the UE configuration when receiving the LTM cell switch command indicating to the UE the LTM cell switch procedure.

One or more examples of this disclosure refers to a CSI measurement for LTM, or a L1/L2 measurements or a lower layer measurement to support LTM, which is a measurement based on which the UE derives information to include in a CSI report for LTM e.g. to assist the network to determine to perform L1/L2 inter-cell mobility (LTM cell switch). A CSI measurement is different from a so called RRM measurement reported on an RRC MeasurementReport message, as defined in TS 38.331. An RRM measurement is configured by an RRC measurement configuration (IE MeasConfig in the first ASN.1 level in the RRCReconfiguration message), is Layer 3 filtered, is used as input to trigger an RRC Measurement Report (which is an RRC message), and once reported, is typically used by the network (e.g. the CU) to determine whether the UE needs to be handed over to another cell or not, with an RRC procedure called Reconfiguration with Sync procedure.

Examples of this disclosure include a method at a UE comprising:
Receiving a message including:
   an RS configuration associated to an LTM candidate cell;
   a resource configuration associated to one or more LTM candidate cells;
   a reporting configuration for LTM associated to a resource configuration;
Performing one or more lower layer measurements on one or more LTM candidate cell(s):
   The RS configuration associated to an LTM candidate cell;
Transmitting one or more lower layer reports including the one or more lower layer measurements, based on the received:
   The resource configuration associated to one or more LTM candidate cells;
   The reporting configuration for LTM associated to a resource configuration.

Examples of this disclosure include a method at a network node operating as a Candidate DU comprising:
Transmitting to the CU a message including:
   an RS configuration associated to an LTM candidate cell;

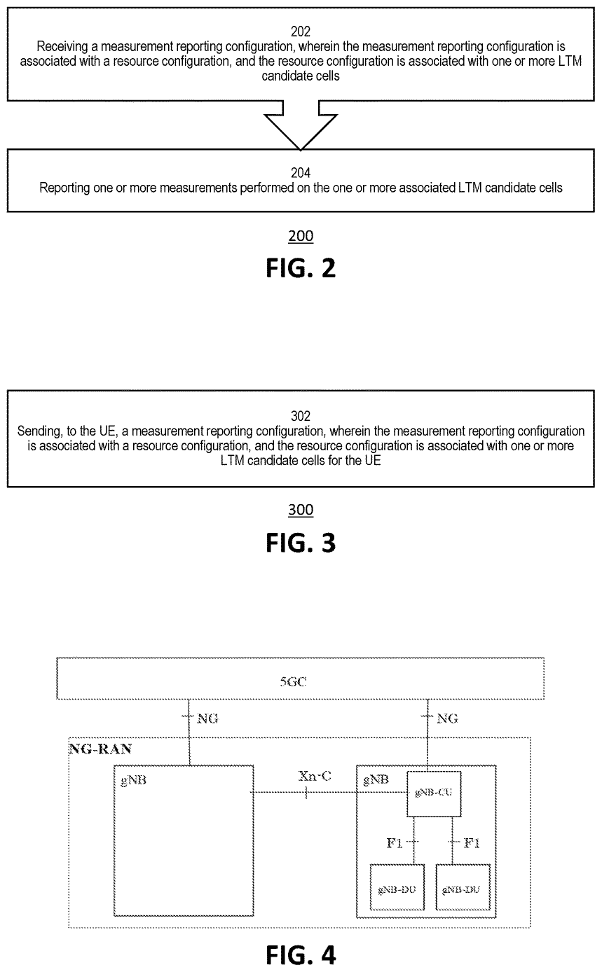

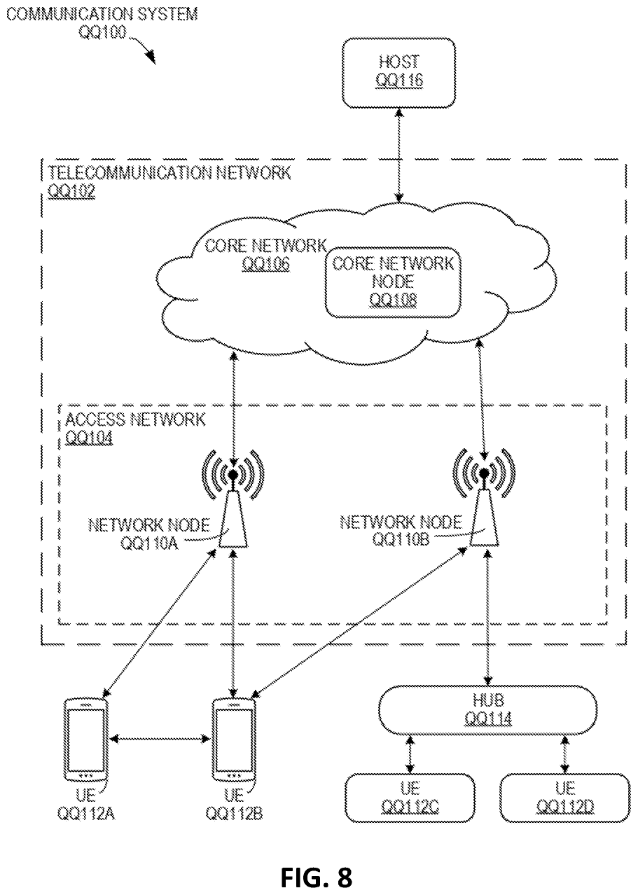

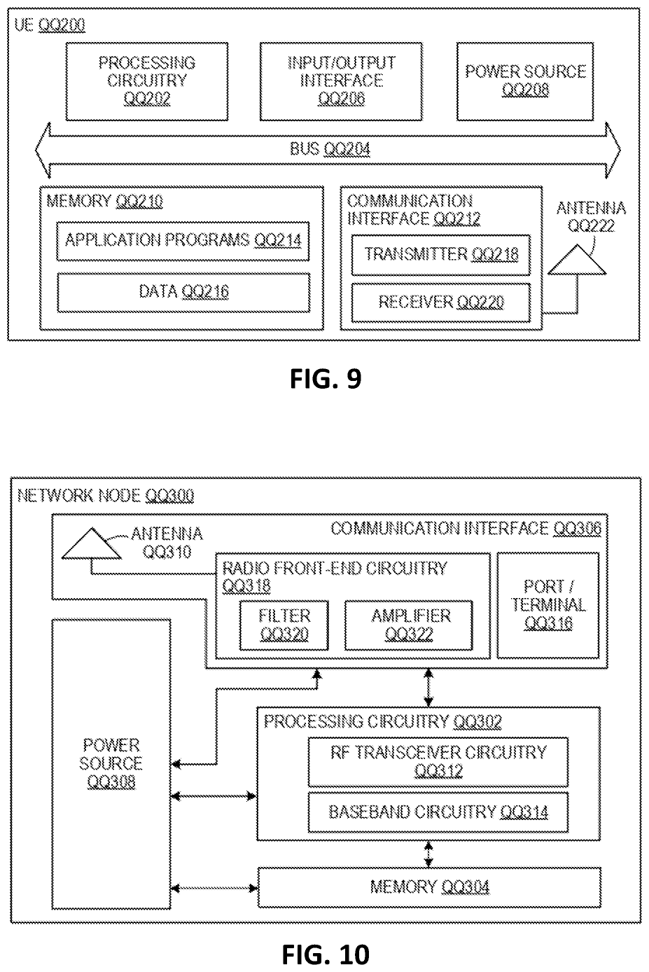

FIG. 2 depicts a method 200 in accordance with particular embodiments, for example a method in a User Equipment (UE) for configuring the UE to perform measurement reporting. The method 200 may be performed by a UE or wireless device (e.g. the UE QQ112 or UE QQ200 as described later with reference to FIGS. 8 and 9 respectively). The method 200 begins at step 202 with receiving a measurement reporting configuration, wherein the measurement reporting configuration is associated with a resource configuration, and the resource configuration is associated with one or more LTM candidate cells. Step 204 of the method 200 comprises reporting one or more measurements performed on the one or more associated LTM candidate cells.

In some examples, the method 200 comprises determining, for the measurement reporting configuration, the one or more associated LTM candidate cells. This may comprise for example determining, from the measurement reporting configuration, an identifier of the associated resource configuration. This may also comprise for example determining, for the resource configuration, the one or more associated LTM candidate cells.

Reporting one or more measurements performed on the one or more associated LTM candidate cells in step 204 of the method 200 may in some examples comprise reporting one or more measurements performed for up to a predetermined maximum number of LTM candidate cells, and/or up to a predetermined maximum number of synchronization signal blocks (SSBs) per LTM candidate cell.

The method 200 may in some examples comprise determining, for the measurement reporting configuration, one or more frequencies of the one or more associated LTM candidate cells. These may be SSB frequencies for example. The frequencies may in some examples be indicated in a reference signal (RS) configuration.

The measurement reporting configuration may in some examples be received in a cell group configuration for the UE (e.g. CellGroupConfig) and/or in a RRC reconfiguration message (e.g. RRCReconfiguration). In some examples, the resource configuration may be LTM-CSI-ResourceConfig. In some examples, the measurement reporting configuration may be CSI-MeasConfig. In some examples, the measurement reporting configuration may be a Channel State Information (CSI) reporting configuration such as LTM-CSI-ReportConfig. In some examples, the method 200 may comprise receiving the resource configuration, for example from a first network node (e.g. as described below with reference to the method 300 of FIG. 3), source distributed unit (S-DU), or gNodeB (gNB). Additionally or alternatively, the method 200 may comprise receiving the measurement reporting configuration from a first network node, S-DU or gNB.

In some examples, reporting, for the measurement reporting configuration, one or more measurements performed on the one or more associated LTM candidate cells in step 204 of the method 200 comprises sending one or more measurement reports to a S-DU or gNB.

The measurement reporting configuration may in some examples identify one or more reference signal (RS) configurations for each LTM candidate cell, e.g. one or more resource sets (e.g. one or more ltm-CSI-SSB-ResourceSet). Reporting one or more measurements performed on the one or more associated LTM candidate cells in step 204 of the method 200 may in some examples comprise reporting one or more measurements performed on a reference signal identified by one of the one or more RS configurations. The reference signal may comprise for example a SSB.

FIG. 3 depicts a method 300 in accordance with particular embodiments, for example a method performed by a first network node for configuring a User Equipment (UE) for measurement reporting. The first network node may be e.g. a source distributed unit (S-DU) or source gNB for the UE. The method 300 may be performed by a network node (e.g. the network node QQ110 or network node QQ300 as described later with reference to FIGS. 8 and 10 respectively). The method begins at step 302 with sending, to the UE, a measurement reporting configuration (e.g. CSI reporting configuration), wherein the measurement reporting configuration is associated with a resource configuration, and the resource configuration is associated with one or more L1/L2-triggered mobility (LTM) candidate cells for the UE. 3 The method 300 may also in some examples comprise sending the resource configuration to the UE. In some examples, the UE may perform the method 200 described above with reference to FIG. 2.

In some examples, the method 300 may comprise receiving, from a second network node (e.g. a central unit, CU), information identifying the one or more LTM candidate cells for the UE.

In some examples, the measurement reporting configuration includes an identifier of the associated resource configuration. In some examples, the method comprises receiving, from the second network node (e.g. CU), the associated resource configuration

The method 300 may in some examples comprise receiving, from the UE, one or more measurements performed by the UE for up to a predetermined maximum number of LTM candidate cells, and/or up to a predetermined maximum number of synchronization signal blocks (SSBs) per LTM candidate cell.

In some examples, the measurement reporting configuration identifies one or more measurement frequencies for each the one or more LTM candidate cells. The one or more frequencies for each of the one or more the LTM candidate cells may comprise for example one or more SSB frequencies for each of the one or more the LTM candidate cells.

The measurement reporting configuration may in some examples be sent to the UE in step 302 of the method 300 in a cell group configuration for the UE, and/or in a RRC reconfiguration message. The cell group configuration for the UE and/or the RRC reconfiguration message may in some examples be received from the second network node (e.g. CU). The method 300 may also in some examples comprise sending the cell group configuration for the UE to the second network node, wherein the cell group configuration includes information identifying the measurement reporting configuration.

In some examples, the measurement reporting configuration identifies one or more reference signal (RS) configurations for each LTM candidate cell. The method may thus in some examples comprise receiving, from the second network node (e.g. CU), information identifying the one or more RS configurations for each LTM candidate cell.

The method 300 may in some examples comprise receiving, from the UE, one or more measurements performed by the UE on the one or more associated LTM candidate cells, for example as sent by the UE according to step 204 of the method 200.

In some examples of this disclosure, a measurement comprises a CSI measurement which comprises one or more of the following non-limiting examples:
Synchronization Signal (SS) Reference Signal Received Power (SS-RSRP) of a L1/L2 inter-cell mobility candidate cell, for at least one configured/indicated SSB of the L1/L2 inter-cell mobility candidate cell. The SS-RSRP is measured only among the reference signals corresponding to SS/PBCH blocks (SSBs) with the same SS/PBCH block (SSB) index and the same physical-layer cell identity (PCI) of the L1/L2 inter-cell candidate cell.
   In one embodiment the SS-RSRP may be derived as the linear average over the power contributions (in [W]) of the resource elements that carry secondary synchronization signals (SSSs) of the L1/L2 inter-cell candidate cell.
   In one embodiment, the SS-RSRP determination is based on the demodulation reference signals for physical broadcast channel (PBCH) of the L1/L2 inter-cell candidate cell; and, if indicated by higher layers, CSI reference signals of the L1/L2 inter-cell candidate cell, in addition to secondary synchronization signals may be used.
   In one embodiment, the SS-RSRP indicate certain SS/PBCH blocks for performing SS-RSRP measurements, then SS-RSRP is measured only from the indicated set of SS/PBCH block(s).
   In one embodiment, the SS-RSRP is used for L1-RSRP to be included in a CSI report;
SS reference signal received quality (SS-RSRQ) of a L1/L2 inter-cell mobility candidate cell, for at least one configured/indicated SSB of the L1/L2 inter-cell mobility candidate cell.
SS signal-to-noise and interference ratio (SS-SINR) of a L1/L2 inter-cell mobility candidate cell, for at least one configured/indicated SSB of the L1/L2 inter-cell mobility candidate cell.
CSI Reference Signal Received Power (CSI-RSRP) of a L1/L2 inter-cell mobility candidate cell, for at least one configured/indicated CSI-RS resource of the L1/L2 inter-cell mobility candidate cell.
   In one embodiment, the CSI-RSRP comprises the linear average over the power contributions (in [W]) of the resource elements of the antenna port(s) that carry CSI reference signals configured for RSRP measurements within the considered measurement frequency bandwidth in the configured CSI-RS occasions, for the L1/L2 inter-cell mobility candidate cell.
CSI reference signal received quality (CSI-RSRQ) of a L1/L2 inter-cell mobility candidate cell, for at least one configured/indicated CSI-RS resource of the L1/L2 inter-cell mobility candidate cell.
CSI signal-to-noise and interference ratio (CSI-SINR) of a L1/L2 inter-cell mobility candidate cell, for at least one configured/indicated CSI-RS resource of the L1/L2 inter-cell mobility candidate cell.
Layer 1 Reference Signal Received Power (L1-RSRP) based on at least one SSB of a L1/L2 inter-cell mobility candidate cell.
Layer 1 Reference Signal Received Power (L1-RSRP) based on at least one CSI-RS resource of a L1/L2 inter-cell mobility candidate cell.
Layer 1 SINR (L1-SINR) based on at least one SSB of a L1/L2 inter-cell mobility candidate cell.
Layer 1 SINR (L1-SINR) based on at least one CSI-RS resource of a L1/L2 inter-cell mobility candidate cell.
Channel Quality Indicator (CQI) of a L1/L2 inter-cell mobility candidate cell, based on SSB and/or CSI-RS in the CSI resource configuration;
Precoding matrix indicator (PMI) of a L1/L2 inter-cell mobility candidate cell, based on SSB and/or CSI-RS in the CSI resource configuration;
CSI-RS resource indicator (CRI) of a L1/L2 inter-cell mobility candidate cell, based on SSB and/or CSI-RS in the CSI resource configuration;
SS/PBCH Block Resource indicator (SSBRI) of a L1/L2 inter-cell mobility candidate cell, based on SSB and/or CSI-RS in the CSI resource configuration;
Layer indicator (LI) of a L1/L2 inter-cell mobility candidate cell, based on SSB and/or CSI-RS in the CSI resource configuration;
Rank indicator (RI) of a L1/L2 inter-cell mobility candidate cell, based on SSB and/or CSI-RS in the CSI resource configuration.

FIG. 4 illustrates an example of an overall architecture with both NG-RAN and 5GC, with NG-RAN split in CU and DU connected via F1 interface, for what in examples of this disclosure are referred to as a CU and a DU in a Radio Access Network (RAN). In this particular example, the RAN is a Next-Generation RAN (NG-RAN), which may be referred as the 5G RAN, however, the method is applicable to any RAN such as a 6G RAN architecture.

The RAN (e.g. NG-RAN) consists of a set of RAN nodes (e.g. gNBs) connected to a Core Network (e.g. a 5G Core, 5GC) through a RAN/CN interface (e.g. NG interface). In the case of NG-RAN, that may comprise one or more ng-eNBs, wherein an ng-eNB may consist of an ng-eNB-CU and one or more ng-eNB-DU(s). A gNB may consist of a gNB-CU and one or more gNB-DU(s). A gNB-CU and a gNB-DU is connected via F1 interface. A gNB-DU may be connected to multiple gNB-CUs by appropriate implementation. The method is presented as applicable to the NG-RAN as an example, however, the method is also applicable to any RAN architecture, such as a 6G RAN.

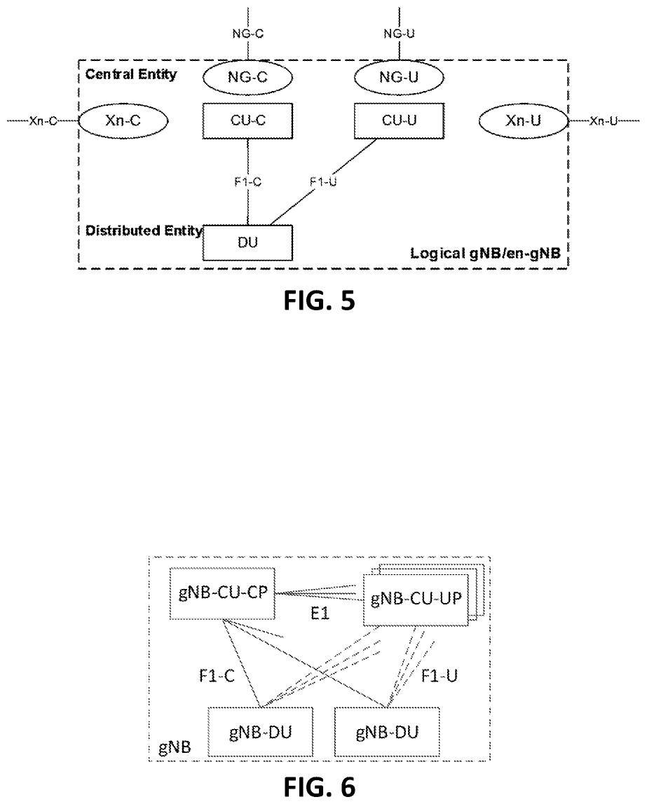

NG, Xn and F1 are logical interfaces. And, in case of the NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB. A possible deployment scenario is shown in FIG. 5, which illustrates an example deployment of a logical gNB/en-gNB. The Protocol terminations of the NG and Xn interfaces are depicted as ellipses, and the terms “Central Entity” and “Distributed Entity” shown in FIG. 5 refer to physical network nodes.

FIG. 6 illustrates an example of an overall architecture for separation of gNB-CU-CP and gNB-CU-UP. As illustrated in FIG. 6:
A gNB may consist of a gNB-CU-CP, multiple gNB-CU-UPs and multiple gNB-DUs;
The gNB-CU-CP may be connected to the gNB-DU through the F1-C interface;
The gNB-CU-UP may be connected to the gNB-DU through the F1-U interface;
The gNB-CU-UP may be connected to the gNB-CU-CP through the E1 interface;
One gNB-DU may be connected to only one gNB-CU-CP;
One gNB-CU-UP may be connected to only one gNB-CU-CP;
One gNB-DU may be connected to multiple gNB-CU-UPs under the control of the same gNB-CU-CP;
One gNB-CU-UP may be connected to multiple DUs under the control of the same gNB-CU-CP.

Thus, when examples of this disclosure refer to a method performed by a CU, the method may in some examples comprise the action(s) being performed by any entities comprised within the CU, e.g. CU-CP, gNB-CU-CP.

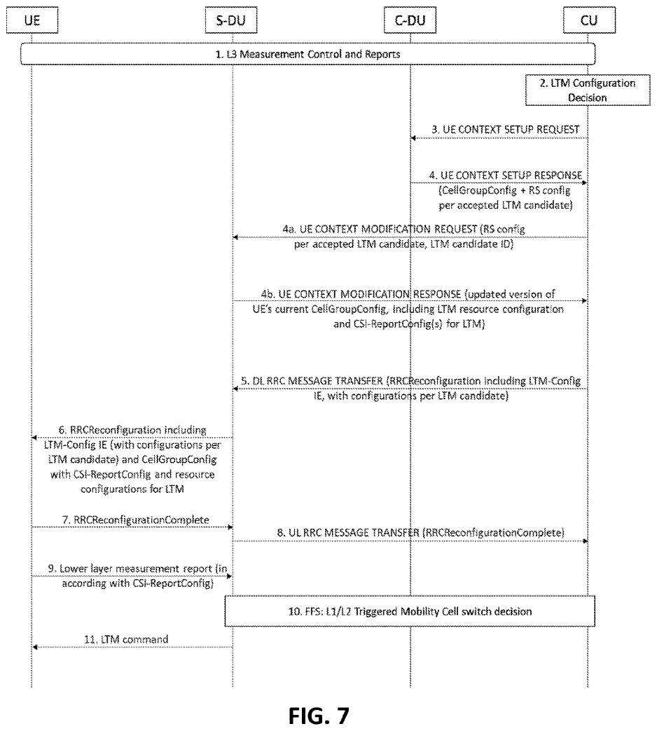

FIG. 7 illustrates an example of a signaling flow in example methods according to embodiments of this disclosure. An example method relating to the signaling flow shown in FIG. 7 includes the following steps. The example method may be an example implementation of the method 200 and/or the method 300 described above.

Steps 1, 2, 3: In one set of embodiments, UE sends a MeasurementReport message (L3 measurement result) to the S-DU (e.g. source gNB-DU) containing measurements of neighboring cells e.g. RSRP per cell on a frequency indicated in a measurement object (e.g. MeasObjectNR). The S-DU sends an UL RRC MESSAGE TRANSFER message conveying the received MeasurementReport message to the gNB-CU. The CU (e.g. gNB-CU in case of NG-RAN) determines to configure a UE with LTM i.e. to initiate a L1/L2 triggered mobility configuration.

Then, the CU sends a UE CONTEXT SETUP REQUEST message in step 3 to a Candidate DU (e.g. candidate gNB-DU), denoted C-DU, associated to one or more cells which the CU requests to be configured as LTM candidate cell(s). In one option, the requested cell(s) in the UE CONTEXT SETUP REQUEST is one of the cells the UE has reported and was included in the MeasurementReport message (L3 measurement result).

In a set of embodiments, the C-DU receives a request for configuring LTM for one or more of its associated cells. In response to that request, the C-DU accepts one or more of the requested cells as LTM candidate cells and includes for at least one of the LTM candidate cell, in a response message to the CU (e.g. UE CONTEXT MODIFICATION RESPONSE or UE CONTEXT SETUP RESPONSE), a Reference Signal (RS) configuration, including one or more of the following:
A Physical Cell Identifier (PCI) e.g. an INTEGER (0 . . . 1007)
SS/PBCH block measurement timing configuration (SMTC) configuration, including
   At least one information about periodicity and offset (e.g. periodicityAndOffset) of the measurement window in which the UE is to receive SS/PBCH blocks (SSBs). Periodicity and offset are given in number of time domain units such as frames, subframes, time slots, etc.
   At least one duration information of the measurement window in which to receive SSBs. For example, that may be given in number of time domain units such as frames, subframes, time slots, etc.
Frequency information
   In one option that is an SSB frequency, possibly expressed in terms of an absolute frequency value such as an Absolute radio-frequency channel number (ARFCN) and/or an NR global frequency raster (e.g. as defined in TS 38.101)
An SSB pattern, indicating which SSBs are assumed to be transmitted for that cell
   In one option, that is one or more SSB indexes indicating the SSBs which are assumed to be transmitted e.g. (2, 7, 24) means the UE assumes the candidate cell is transmitting SSBs whose SSB indexes are 2, 7, and 24.
   In one option, that is indicated as a bit string in which a value “1” indicates an SSB is transmitted and a value “0” indicates that an SSB is not transmitted). For example, the following bit string [0 1 0 0 0 1] indicates that the LTM candidate cell is transmitting 2 SSB(s) whose indexes are SSB index 1 and SSB index 5.
Subcarrier Spacing of SSB.
   For example, the UE may receive an indication of the values 15 kHz or 30 KHz (FR1), and 120 kHz or 240 kHz (FR2).
One or more groups of SSB(s)
   In one option, that may be grouped in resource set(s) e.g. SSB set 1 (SSB 1, SSB 2), SSB set 2 (SSB 3, SSB 4), etc.
   In one option, that is a list of SSB(s) of the LTM candidate cell.
One or more groups of CSI-RS resource(s)
   In one option, that may be grouped in resource set(s) e.g. CSI-RS set 1 (CSI-RS resource 1, CS-RS Resource 2), CSI-RS set 2 (CSI-RS resource 3, CSI-RS resource 4), etc.
   In one option, that is a list of CSI-RS resource(s) of the LTM candidate cell.
   In one option, the detailed configuration(s) of each CSI-RS resource may also be provided in the RS configuration.

In one option for that set of embodiments, the request for configuring LTM for one or more of its associated cells the C-DU receives corresponds to a UE CONTEXT SETUP REQUEST or a UE CONTEXT MODIFICATION REQUEST, including an indication of at least a cell (e.g. cell ID) which the CU requests the C-DU to configured as an LTM candidate cell.

In one option for that set of embodiments, the response message to the CU may correspond to a UE CONTEXT u at least one cell of the C-DU which has been accepted to be an LTM candidate cell.

In one option for that set of embodiments, the Reference Signal (RS) configuration for an LTM candidate cell, included in the response message from the C-DU to the CU, (e.g. UE CONTEXT MODIFICATION RESPONSE or UE CONTEXT SETUP RESPONSE), is included in an RRC Container e.g. an inter-node RRC message defined in TS 38.331.

In one option for that set of embodiments, the Reference Signal (RS) configuration for an LTM candidate cell, included in the response message from the C-DU to the CU, (e.g. UE CONTEXT MODIFICATION RESPONSE or UE CONTEXT SETUP RESPONSE), is included in a first RRC Container associated to the LTM candidate cell, together with a second RRC Container including the lower layer configuration for that LTM candidate cell e.g. CellGroupConfig for the LTM candidate cell.

Thus, after Step 3, the CU has the RS configuration per LTM candidate cell which has been accepted by the C-DU, received in the response message e.g. UE CONTEXT MODIFICATION RESPONSE or UE CONTEXT SETUP RESPONSE.

Step 4a: In a set of embodiments, the CU transmits to the S-DU the RS configuration for an LTM candidate cell.

In one option, related to set of embodiments, the RS configuration is included by the CU in a UE CONTEXT SETUP REQUEST or a UE CONTEXT MODIFICATION REQUEST to the S-DU. That message may also indicate to the S-DU that the UE is to be configured with one or more LTM candidate cells. This may be the first message in which the S-DU becomes aware that the UE needs to be configured with LTM.

In one sub-option, the S-DU uses that information to configure or re-configure the UE's DRX parameters, measurement gap parameters, as that indicates the LTM candidate cell(s) and/or respective frequencies the UE needs to be configured to measure and report. This step is more related to network implementation.

Step 4b: In one sub-option, the S-DU includes the received RS configuration per LTM candidate cell in an updated version of the UE's current CellGroupConfig e.g. delta signaling. That CellGroupConfig is then sent from the S-DU to the CU (e.g. in a UE CONTEXT MODIFICATION RESPONSE).

Step 5: Then, the CU includes that received CellGroupConfig (which includes the RS configuration per LTM candidate cell) in an RRC Reconfiguration message (e.g. RRCReconfiguration), and that generated RRC Reconfiguration message is transmitted from the CU to the S-DU (e.g. in a DL RRC MESSAGE TRANSFER).

Step 6: The S-DU receives that RRC Reconfiguration message and provides to the UE.

The UE receives that RRC Reconfiguration message including the CellGroupConfig associated to the UE's current serving cell(s) i.e. the CellGroupConfig described in Step 4b and 5, which includes the RS configuration per LTM candidate cell. The UE applies the CellGroupConfig and uses the RS configuration per LTM candidate cell for performing lower layer measurements/CSI measurements associated to that LTM candidate cell e.g. SS-RSRP measurements.

In another option, which may be combined with the previous options, the CU transmits to the S-DU the RS configuration for an LTM candidate cell, and associates it to an LTM candidate identifier e.g. an identifier of N bits, like N=3 in case of a maximum number of candidates being up to 8. In that case, for each cell accepted by the C-DU to be an LTM candidate cell, the CU assigns an LTM candidate ID, which may correspond to an integer from 0 up to the maximum number of LTM candidates minus 1. For example, if it is defined that the UE can be configured with up to 8 LTM candidate cells, the LTM candidate ID space is 0, 1, 2, 3, 4, 5, 6, 7. When the CU transmits to the S-DU the RS configuration to an LTM candidate cell, it also indicates the LTM candidate ID associated to that cell and the corresponding RS configuration. The overall information, e.g., in an RRC container from the CU to the S-DU in the UE CONTEXT MODIFICATION REQUEST, may be as follows:
LTM candidate ID=1→RS Config [PCI A*, SSB frequency, SMTC, SSB pattern]
LTM candidate ID=2→RS Config [PCI B*, SSB frequency, SMTC, SSB pattern]
LTM candidate ID=3→RS Config [PCI C*, SSB frequency, SMTC, SSB pattern]
LTM candidate ID=4→RS Config [PCI D*, SSB frequency, SMTC, SSB pattern]

In that case, the UE receives that RRC Reconfiguration message including the CellGroupConfig associated to the UE's current serving cell(s) i.e. the CellGroupConfig described in Steps 4b and 5, which includes the RS configuration per LTM candidate cell associated to an LTM candidate ID (e.g. ltm-CandidateId, IE LTM-CandidateId). The UE applies the CellGroupConfig and uses the RS configuration per LTM candidate cell for performing lower layer measurements/CSI measurements associated to that LTM candidate cell e.g. SS-RSRP measurements.

An example of the IE the UE receives for the RS configuration is shown below:

LTM-RS-Config : := SEQUENCE {

| | |
|---|---|
| ltm-CandidateId | LTM-CandidateId, |
| physCellId | PhysCellId, |
| smtc | SSB-MTC, |
| ssbFrequency | ARFCN-ValueNR |
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |
| } | |
| } | |
| SSB-MTC : := | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |
| }, | |
| duration | ENUMERATED { sf1, sf2, sf3, sf4, sf5 } |
| } | |
| } | |

// The IE LTM-CandidateId is used to identify an LTM candidate cell configuration.

| | |
|---|---|
| LTM-CandidateId-r18 : := | INTEGER (1.. maxNrofCellsLTM- |
| r18) | |

In the example above, the SSB pattern is provided to the UE as an ssb-PositionsInBurst which indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

Step 4a (alternative to the above described step 4a): In another set of embodiments, which may be combined with the previous options and sets of embodiments, the CU transmits to the S-DU the RS configuration for an LTM candidate cell, and associates it to an LTM candidate identifier e.g. in the UE CONTEXT MODIFICATION REQUEST. As indicated above, that may be the first message indicating to the S-DU that the CU requests the configuration of LTM.

In one option, in response to that, the S-DU generates at least one instance of a reporting configuration, e.g. a CSI-ResourceConfig IE for LTM (e.g. CSI-ReportConfig or LTM-CSI-ReportConfig), to be configured at the so the UE knows how to report measurements on one or more LTM candidate cells to an Uplink channel of one of the UE's current serving cells e.g. PCell or one of the Scell(s) the UE is configured with.

Step 4b (alternative to the above described step 4b): In one option, The S-DU includes the CSI-ReportConfig IE instance for LTM, for a lower layer report for LTM, in a Serving cell configuration (e.g. ServingCellConfig, in CSI-MeasConfig) of the UE's current configuration. That is included in the serving cell configuration of the serving cell in which the UE shall report these lower layer measurements for LTM. As the serving cell configuration is within the UE's current CellGroupConfig, the S-DU transmits to the CU an updated version of the UE's current CellGroupConfig e.g. delta signaling with the modified ServingCellConfig, including the instance of the CSI-ReportConfig for LTM. That CellGroupConfig is then sent from the S-DU to the CU (e.g. in a UE CONTEXT MODIFICATION RESPONSE). Then, the CU includes that received CellGroupConfig (which includes the RS configuration per LTM candidate cell) in an RRC Reconfiguration message (e.g. RRCReconfiguration), and that generated RRC Reconfiguration message is transmitted from the CU o the S-DU (e.g. in a DL RRC MESSAGE TRANSFER).

Step 5 (alternative to the above described step 5): Then, the CU includes that received CellGroupConfig (which includes the CSI-ReportConfig for LTM) in an RRC Reconfiguration message (e.g. RRCReconfiguration), and that generated RRC Reconfiguration message is transmitted from the CU o the S-DU (e.g. in a DL RRC MESSAGE TRANSFER).

Step 6 (alternative to the above described step 6): The S-DU receives that RRC Reconfiguration message and provides to the UE. The UE receives that RRC Reconfiguration message including the CellGroupConfig associated to the UE's current serving cell(s) i.e. the CellGroupConfig described in Ste 4b and 5, which includes the CSI-ReportConfig for configuring lower layer reports for LTM candidate cell(s), to be reported to the UE's current serving cell(s) e.g. the PCell.

In a set of embodiments, a UE is configured to transmit a single lower layer report for LTM which includes LTM candidate cell(s) which are intra-frequency and/or inter-frequency. That is reported based on the UE receiving a CSI-ReportConfig instance for LTM which point to a resource configuration which may either be intra-frequency LTM candidate cell(s) and/or inter-frequency LTM candidate cell(s). In this context, an intra-frequency candidate is a candidate whose SSB frequency and subcarrier spacing (SCS) of the candidate SpCell are the same as the SSB frequency and SCS of the UE's current SpCell. And/or, an inter-frequency candidate is a candidate whose SSB frequency or subcarrier spacing (SCS) of the candidate SpCell differ from the SSB frequency or the SCS of the UE's current SpCell.

There are at least three alternatives for defining such a pointer within a CSI-ReportConfig for LTM, to indicate to the UE what may be included in terms of LTM candidate cell(s) for the measurements to be reported according to that CSI-ReportConfig instance for LTM:
Alternative a) LTM flag
Alternative b) List of candidate frequencies
Alternative c) List of LTM candidate cell(s)

Alternative a) the UE receives a CSI-ReportConfig for LTM which includes an LTM flag or indication (or field or parameter) which indicates that the CSI-ReportConfig instance is for LTM. Based on that the UE assumes that all configured LTM candidate cell(s) and their SSBs may be associated to that report.
In one option, a maximum number of LTM candidate cells and SSB(s) per LTM candidate cell to be included per lower layer report is defined, so that the fact that the resource configuration points to all LTM candidate cells of course does not mean the UE would necessarily measure all LTM candidate cells all the time and include all measured SSB(s) of all LTM candidate cell(s) in each CSI report instance for LTM.

Alternative b) the UE receives a CSI-ReportConfig instance for LTM which is associated to one or multiple frequencies (e.g. SSB frequencies), so that a lower layer report (or CSI report for LTM) contains measurements on the SSB(s) of the LTM candidate cell(s) whose frequencies are indicated in the CSI-ReportConfig instance.
In one option the one or multiple frequencies are indicated as one or more SSB frequencies, with respective ARFCN values.
In one option the one or multiple frequencies are indicated as measurement object identifier(s), wherein each measurement object is configured in the Measurement Configuration e.g. in the UE-VarMeasConfig if previously configured.

Alternative c), the UE receives an CSI-ReportConfig instance associated to sets of LTM candidate cells, so that a lower layer report for LTM (or CSI report for LTM) contains measurements on the SSB(s) of the LTM candidate cell(s) whose set has been indicated in the CSI-ReportConfig instance.
In one option each resource configuration is associated to one or more LTM candidate ID(s) e.g. determined by the CU or the S-DU.
In one option each resource configuration is associated to one or more PCI+ARFCN combination(s).

Step 4a (alternative to the above described steps 4a) When it comes to the network signaling and actions between S-DU, CU and C-DU to enable the UE to be configured with an instance of an CSI-ReportConfig for LTM indicating a resource configuration (e.g. LTM indication, set of frequencies or set of LTM candidate cell(s)), there may be different alternatives.

In a set of embodiments, which may be combined with the previous options and sets of embodiments, the CU transmits to the S-DU an LTM candidate identifier for each LTM candidate cell, possibly including the RS configuration for each LTM candidate cell e.g. in the UE CONTEXT MODIFICATION REQUEST. As indicated above, that may be the first message indicating to the S-DU that the CU requests the configuration of LTM.

In response to that, the S-DU associates one or more LTM candidate cells to an instance of a CSI-ReportConfig for LTM.
In one option, the S-DU generates one or more resource configuration, each associated to a resource configuration ID comprising one or more LTM candidate cell ID(s). The S-DU includes a pointer of a resource configuration (e.g. resource configuration ID) in the instance of a CSI-ReportConfig for LTM. For example, the S-DU may receive the following from the CU, in the UE CONTEXT MODIFICATION REQUEST:
LTM candidate ID=1→RS Config [PCI A*, SSB frequency, SMTC]
LTM candidate ID=2→RS Config [PCI B*, SSB frequency, SMTC]
LTM candidate ID=3→RS Config [PCI C*, SSB frequency, SMTC]
LTM candidate ID=4→RS Config [PCI D*, SSB frequency, SMTC]

Then, in response, it generates the following resource configuration(s) and associated resource configuration ID(s) 1 and 2:
LTM-CSI-ResourceConfigId ID=1→LTM candidate ID=1, LTM candidate ID=2;
LTM-CSI-ResourceConfigId ID=2→LTM candidate ID=3, LTM candidate ID=4;

After having generated the resource configuration(s) for the one or more LTM candidate cell(s) and/or combinations, as shown above, the S-DU includes a pointer to the resource configuration in an instance of the CSI-ReportConfig for LTM, for example:
CSI-ReportConfig ID=1→LTM-CSI-ResourceConfigId ID=1;
CSI-ReportConfig ID=2→LTM-CSI-ResourceConfigId ID=2;

When the UE receives a CSI-ReportConfig for LTM, including a resource configuration ID, the UE knows for which LTM candidate cell(s) lower layer measurements are to be included for the CSI-ReportConfig instance for LTM. For example, for the CSI-ReportConfig whose ID=2, which includes LTM-CSI-ResourceConfigId ID=2, the UE is indicated that a resource configuration for LTM whose ID=2 includes the LTM candidate cell whose ID=3 and includes the LTM candidate cell whose ID=4.

In another option, the S-DU includes one or more LTM candidate cell ID(s) in an instance of a CSI-ReportConfig for LTM, to indicate the resource configuration i.e. in that option there is no need to define a resource configuration ID. For example:
CSI-ReportConfig ID=1→LTM candidate ID=1, LTM candidate ID=2;
CSI-ReportConfig 1D=2→LTM candidate ID=3, LTM candidate ID=4;
Step 4b (alternative to the above described steps 4b): In response to that, after the S-DU associates one or more LTM candidate cells to an instance of a CSI-ReportConfig for LTM, the S-DU includes the CSI-ReportConfig IE instance for LTM, for a lower layer report for LTM, in a Serving cell configuration (e.g. ServingCellConfig, in CSI-MeasConfig) of the UE's current configuration. That is included in the serving cell configuration of the serving cell in which the UE shall report these lower layer measurements for LTM. As the serving cell configuration is within the UE's current CellGroupConfig, the S-DU transmits to the CU an updated version of the UE's current CellGroupConfig e.g. delta signaling with the modified ServingCellConfig, including the instance of the CSI-ReportConfig for LTM.

In addition to it, the S-DU includes in the UE's current CellGroupConfig to be updated the resource configuration(s), in which one or multiple LTM candidate cell(s) are defined per resource configuration.

That CellGroupConfig is then sent from the S-DU to the CU (e.g. in a UE CONTEXT MODIFICATION RESPONSE). Then, the CU includes that received CellGroupConfig (which includes the CSI-ReportConfig and resource configuration(s)) in an RRC Reconfiguration message (e.g. RRCReconfiguration), and that generated RRC Reconfiguration message is transmitted from the CU o the S-DU (e.g. in a DL RRC MESSAGE TRANSFER).

Step 5 (alternative to the above described steps 5): Then, the CU includes that received CellGroupConfig (which includes the CSI-ReportConfig for LTM and resource configuration(s)) in an RRC Reconfiguration message (e.g. RRCReconfiguration), and that generated RRC Reconfiguration message is transmitted from the CU to the S-DU (e.g. in a DL RRC MESSAGE TRANSFER).

Step 6 (alternative to the above described steps 6): The S-DU receives that RRC Reconfiguration message and provides to the UE. The UE receives that RRC Reconfiguration message including the CellGroupConfig associated to the UE's current serving cell(s) i.e. the CellGroupConfig described in Steps 4b and 5, which includes the CSI-ReportConfig for configuring lower layer reports for LTM candidate cell(s), to be reported to the UE's current serving cell(s) e.g. the PCell, associated to a resource configuration (e.g. by including a resource configuration ID in the CSI-ReportConfig for LTM) and the resource configuration(s), each associated to one or more LTM candidate cell(s).

When the UE receives the RRC Reconfiguration the UE determines for each CSI-ReportConfig for LTM what is the associated resource configuration, indicated by the included resource configuration ID. Then, in the resource configuration the UE also received, the UE determines for the corresponding ID, which LTM candidate cell(s) and/or frequencies of the LTM candidate cell(s) are associated to that resource configuration ID and, consequently, to be included in the lower layer report configured by that CSI-ReportConfig instance for LTM.

Step 4a (alternative to the above described steps 4a): In a set of embodiments, which may be combined with the previous options and sets of embodiments, the CU transmits to the S-DU an LTM candidate identifier for each LTM candidate cell, possibly including the RS configuration for each LTM candidate cell e.g. in the UE CONTEXT MODIFICATION REQUEST. As indicated above, that may be the first message indicating to the S-DU that the CU requests the configuration of LTM.

In addition, the CU indicates sets of LTM candidate cells, enabling the S-DU to generate resource configuration(s) associated to these groups. For example, the CU needs to indicate to the S-DU the group(s) of cell(s) and/or frequencies, which serves as input for the S-DU to define the resource configuration(s) and the association to CSI-ReportConfig instances for LTM, for example, as follows:
Group 1→LTM candidate ID=1, LTM candidate ID=2;
Group 2→LTM candidate ID=3, LTM candidate ID=4;

In response to that, the S-DU associates the indicated groups or set of LTM candidate cells to an instance of a CSI-ReportConfig for LTM.
In one option, the S-DU generates one or more resource configuration, based on the received group info, each associated to a resource configuration ID comprising one or more LTM candidate cell ID(s). The S-DU includes a pointer of a resource configuration (e.g. resource configuration ID) in the instance of a CSI-ReportConfig for LTM. For example, the S-DU may receive the following from the CU, in the UE CONTEXT MODIFICATION REQUEST:
LTM candidate ID=1→RS Config [PCI A*, SSB frequency, SMTC]
LTM candidate ID=2→RS Config [PCI B*, SSB frequency, SMTC]
LTM candidate ID=3→RS Config [PCI C*, SSB frequency, SMTC]
LTM candidate ID=4→RS Config [PCI D*, SSB frequency, SMTC]

Then, in response, it generates the following resource configuration(s) and associated resource configuration ID(s) 1 and 2, based on the info determined by the CU:
LTM-CSI-ResourceConfigId ID=1→LTM candidate ID=1, LTM candidate ID=2;
LTM-CSI-ResourceConfigId ID=2→LTM candidate ID=3, LTM candidate ID=4;

After having generated the resource configuration(s) for the one or more LTM candidate cell(s) and/or combinations, as shown above, based on the group info received from the CU, the S-DU includes a pointer to the resource configuration in an instance of the CSI-ReportConfig for LTM, for example:
CSI-ReportConfig ID=1→LTM-CSI-ResourceConfigId ID=1;
CSI-ReportConfig ID=2→LTM-CSI-ResourceConfigId ID=2;

When the UE receives a CSI-ReportConfig for LTM, including a resource configuration ID, the UE knows for which LTM candidate cell(s) lower layer measurements are to be included for the CSI-ReportConfig instance for LTM. For example, for the CSI-ReportConfig whose ID=2, which includes LTM-CSI-ResourceConfigId ID=2, the UE is indicated that a resource configuration for LTM whose ID=2 includes the LTM candidate cell whose ID=3 and includes the LTM candidate cell whose ID=4.
In another option, the S-DU includes one or more LTM candidate cell ID(s) in an instance of a CSI-ReportConfig for LTM, to indicate the resource configuration i.e. in that option there is no need to define a resource configuration ID. For example:
CSI-ReportConfig ID=1→LTM candidate ID=1, LTM candidate ID=2;
CSI-ReportConfig ID=2→LTM candidate ID=3, LTM candidate ID=4;

FIG. 8 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 8, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, a content source and analytics node, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 9 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs). The processing circuitry QQ202 may be operable to provide, either alone or in conjunction with other UE QQ200 components, such as the memory QQ210, UE QQ200 functionality. For example, the processing circuitry QQ202 may be configured to cause the UE QQ202 to perform the methods as described with reference to FIG. 2.

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In some embodiments, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE QQ200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes processing circuitry QQ302, a memory QQ304, a communication interface QQ306, and a power source QQ308, and/or any other component, or any combination thereof. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, network node QQ300 functionality. For example, the processing circuitry QQ302 may be configured to cause the network node to perform the methods as described with reference to FIG. 3.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 10 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

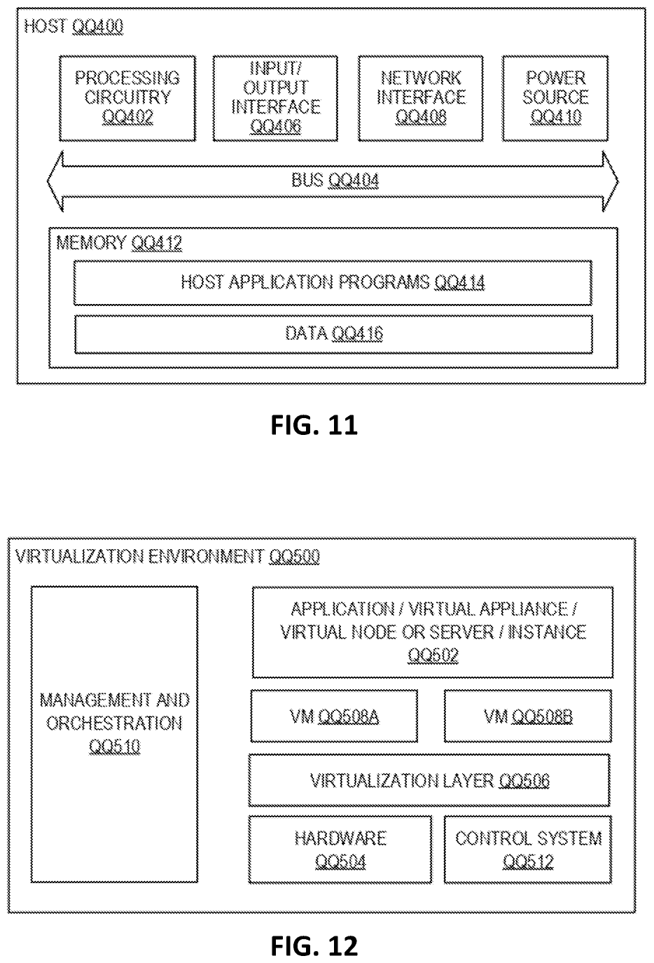

FIG. 11 is a block diagram of a host QQ400, which may be an embodiment of the host QQ116 of FIG. 8, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 9 and 10, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

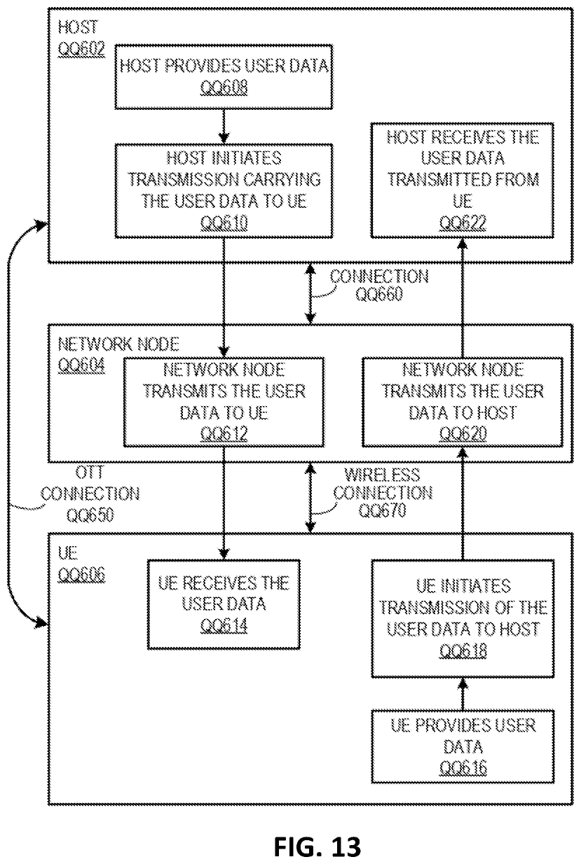

FIG. 13 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 8 and/or UE QQ200 of FIG. 9), network node (such as network node QQ110a of FIG. 8 and/or network node QQ300 of FIG. 10), and host (such as host QQ116 of FIG. 8 and/or host QQ400 of FIG. 11) discussed in the preceding paragraphs will now be described with reference to FIG. 13.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 8) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the LTM candidate cell measurement configuration procedure.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

This disclosure includes the following enumerated embodiments:

### EMBODIMENTS

### Group A Embodiments

1. A method in a User Equipment (UE) for configuring the UE to perform measurement reporting, the method comprising:
   receiving one or more measurement reporting configurations;
   determining, for each of the one or more measurement reporting configurations, one or more associated L1/L2-triggered mobility (LTM) candidate cells; and
   reporting, for each of one or more of the one or more measurement reporting configurations, one or more measurements performed on the one or more associated LTM candidate cells.
2. The method of embodiment 1, wherein determining, for each of the one or more measurement reporting configurations, one or more associated LTM candidate cells comprises determining, from each of the one or more measurement reporting configurations, an identifier of the one or more associated LTM candidate cells.
3. The method of embodiment 1, determining, for each of the one or more measurement reporting configurations, one or more associated LTM candidate cells comprises determining, from each of the one or more measurement reporting configurations, an identifier of one or more associated resource configurations.
4. The method of embodiment 3, comprising determining, for each resource configuration, one or more associated LTM candidate cells.
5. The method of embodiment 1, wherein determining, for each of the one or more measurement reporting configurations, one or more associated LTM candidate cells comprises determining that the one or more measurement reporting configurations indicates that the one or more measurement reporting configurations applies for all LTM candidate cells for the UE.
6. The method of any of embodiments 1 to 5, wherein reporting, for each of one or more of the one or more measurement reporting configurations, one or more measurements performed on the one or more associated LTM candidate cells comprises reporting, for each of one or more of the one or more measurement reporting configurations, one or more measurements performed for up to a predetermined maximum number of LTM candidate cells and/or up to a predetermined maximum number of synchronization signal blocks (SSBs) per LTM candidate cell.
7. The method of any of embodiments 1 to 6, wherein determining, for each of the one or more measurement reporting configurations, one or more associated LTM candidate cells comprises determining, for each of the one or more measurement reporting configurations, one or more frequencies of the associated LTM candidate cells.
8. The method of embodiment 7, wherein determining one or more frequencies comprises determining one or more synchronization signal block (SSB) frequencies.
9. The method of any of embodiments 1 to 8, wherein the one or more measurement reporting configurations is received:
   in a cell group configuration for the UE; and/or
   in a RRC reconfiguration message.
10. The method of any of embodiments 1 to 9, wherein the one or more measurement reporting configurations is received from a source distributed unit (S-DU).
11. The method of any of embodiments 1 to 10, wherein the one or more measurement reporting configurations comprises one or more channel state information (CSI) reporting configurations.
12. The method of any of any of embodiments 1 to 11, wherein reporting, for each of one or more of the one or more measurement reporting configurations, one or more measurements performed on the one or more associated LTM candidate cells comprises sending one or more measurement reports to a source distributed unit (S-DU).
13. The method of any of embodiments 1 to 12, wherein the one or more measurement reporting configurations identify one or more reference signal (RS) configurations for each LTM candidate cell.
14. The method of embodiment 13, wherein reporting, for each of one or more of the one or more measurement reporting configurations, one or more measurements performed on the one or more associated LTM candidate cells comprises reporting, for each of one or more of the one or more measurement reporting configurations, one or more measurements performed on a reference signal identified by one of the one or more RS configurations.
15. The method of any of the previous embodiments, further comprising:
   providing user data; and
   forwarding the user data to a host via the transmission to the network node.

### Group B Embodiments

16. A method performed by a first network node for configuring a User Equipment (UE) for measurement reporting, the method comprising:
   sending, to the UE, one or more measurement reporting configurations, wherein each of the one or more measurement reporting configurations identifies one or more associated L1/L2-triggered mobility (LTM) candidate cells for the UE.
17. The method of embodiment 16, wherein each of the one or more measurement reporting configurations includes an identifier of the one or more associated LTM candidate cells.
18. The method of embodiment 17, comprising receiving, from the second network node, information identifying the one or more LTM candidate cells for the UE.
19. The method of embodiment 17 or 18, comprising receiving, from the second network node, information identifying the identifier for each LTM candidate cell.
20. The method of embodiment 16, wherein each of the one or more measurement reporting configurations includes an identifier of one or more associated resource configurations.
21. The method of embodiment 19, wherein:
   each identifier of a resource configuration is associated with a LTM candidate cell for the UE; and/or
   each of the one or more measurement reporting configurations includes an identifier for identifying an association between a resource configuration and a LTM candidate cell for the UE.
22. The method of embodiment 18 or 19, comprising:
   generating, for each of the one or more measurement reporting configurations, the one or more associated resource configurations; or
   receiving, from the second network node, for each of the one or more measurement reporting configurations, the one or more associated resource configurations.
23. The method of embodiment 20, wherein generating, for each of the one or more measurement reporting configurations, the one or more associated resource configurations is based on one or more reference signal (RS) configurations for each LTM candidate cell for the UE.
24. The method of embodiment 16, wherein the one or more measurement reporting configurations indicates that the one or more measurement reporting configurations applies for all LTM candidate cells for the UE.
25. The method of any of embodiments 16 to 24, comprising receiving, from the UE, for each of one or more of the one or more measurement reporting configurations, one or more measurements performed by the UE for up to a predetermined maximum number of LTM candidate cells and/or up to a predetermined maximum number of synchronization signal blocks (SSBs) per LTM candidate cell.
26. The method of any of embodiments 16 to 25, wherein the one or more measurement reporting configurations identifies one or more measurement frequencies for each the LTM candidate cells.
27. The method of embodiment 26, wherein the one or more frequencies for each the LTM candidate cells comprises one or more synchronization signal block (SSB) frequencies for each the LTM candidate cells.
28. The method of any of embodiments 16 to 27, wherein the one or more measurement reporting configurations is sent to the UE:
   in a cell group configuration for the UE; and/or
   in a RRC reconfiguration message.
29. The method of embodiment 28, wherein the cell group configuration for the UE and/or the RRC reconfiguration message is received from the second network node.
30. The method of embodiment 28 or 29, comprising sending the cell group configuration for the UE to the second network node, wherein the cell group configuration includes information identifying the one or more measurement reporting configurations.
31. The method of any of embodiments 16 to 30, wherein the one or more measurement reporting configurations comprises one or more channel state information (CSI) reporting configurations.
32. The method of any of embodiments 16 to 31, wherein the one or more measurement reporting configurations identify one or more reference signal (RS) configurations for each LTM candidate cell.
33. The method of embodiment 32, comprising receiving, from the second network node, information identifying the one or more reference signal (RS) configurations for each LTM candidate cell.
34. The method of any of embodiments 16 to 33, comprising receiving, from the UE, for each of one or more of the one or more measurement reporting configurations, one or more measurements performed by the UE on the one or more associated LTM candidate cells.
35. The method of any of embodiments 16 to 34, wherein the first network node comprises a source distributed unit (S-DU) for the UE, and/or the second network node comprises a central unit (CU).
36. A method performed by a second network node for configuring a User Equipment (UE) for measurement reporting, the method comprising:
   determining, for each of one or more L1/L2-triggered mobility (LTM) candidate cells for the UE, one or more reference signal (RS) configurations; and
   sending, to a first network node, information identifying the one or more reference signal configurations for each of the one or more LTM candidate cells for the UE.
37. The method of embodiment 36, wherein information identifying the one or more reference signal configurations for each of the one or more LTM candidate cells for the UE is received from at least one third network node.
38. The method of embodiment 37, wherein, for each of the one or more LTM candidate cells for the UE, the information identifying the one or more reference signal configurations for the LTM candidate cell is received from a candidate distributed unit (C-DU) associated with the LTM candidate cell.
39. The method of embodiment 38, wherein information identifying the one or more reference signal configurations for each of the one or more LTM candidate cells for the UE is received from each C-DU in response to a UE context setup request sent to each C-DU.
40. The method of any of embodiments 36 to 39, comprising receiving, from the second network node, information identifying the one or more LTM candidate cells for the UE.
41. The method of any of embodiments 36 to 40, comprising sending, to the first network node, information identifying the identifier for each LTM candidate cell.
42. The method of any of embodiments 36 to 41, comprising
   generating one or more resource configurations based on one or more reference signal (RS) configurations for each LTM candidate cell for the UE; and
   sending the one or more resource configurations to the first network node, wherein each of the one or more resource configurations identifies one or more reference signal configurations for one or more LTM candidate cells for the UE.
43. The method of any of embodiments 36 to 42, comprising sending one or more measurement reporting configurations to the first network node.
44. The method of embodiment 43, wherein the one or more measurement reporting configurations is sent to the first network node:
   in a cell group configuration for the UE; and/or
   in a RRC reconfiguration message for the UE.
45. The method of embodiment 43 or 44, wherein the cell group configuration for the UE is received from the first network node.
46. The method of embodiment 44 or 45, wherein the cell group configuration includes information identifying the one or more measurement reporting configurations.
47. The method of any of embodiments 43 to 46, wherein the one or more measurement reporting configurations comprises one or more channel state information (CSI) reporting configurations.
48. The method of any of embodiments 43 to 47, wherein the one or more measurement reporting configurations identify one or more of the one or more reference signal (RS) configurations for each LTM candidate cell.
49. The method of any of embodiments 36 to 48, wherein the first network node comprises a source distributed unit (S-DU) for the UE, and/or the second network node comprises a central unit (CU).
50. The method of any of the previous embodiments, further comprising:
   obtaining user data; and
   forwarding the user data to a host or a user equipment.

### Group C Embodiments

51. A user equipment for performing a cell switch procedure, comprising:
   processing circuitry configured to cause the user equipment to perform any of the steps of any of the Group A embodiments; and
   power supply circuitry configured to supply power to the processing circuitry.
52. A network node for causing a User Equipment (UE) to perform a cell switch procedure, the network node comprising:
   processing circuitry configured to cause the network node to perform any of the steps of any of the Group B embodiments;
   power supply circuitry configured to supply power to the processing circuitry.
53. A user equipment (UE) for performing a cell switch procedure, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
54. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
55. The host of the previous embodiment, wherein:
   the processing circuitry of the host is configured to execute a host application that provides the user data; and
   the UE comprises processing circuitry configured to execute a client application associated with the host application to receive the transmission of user data from the host.
56. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
57. The method of the previous embodiment, further comprising, at the network node, transmitting the user data provided by the host for the UE.
58. The method of any of the previous 2 embodiments, wherein the user data is provided at the host by executing a host application that interacts with a client application executing on the UE, the client application being associated with the host application.
59. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
60. The communication system of the previous embodiment, further comprising:
   the network node; and/or
   the UE.
61. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
62. The host of the previous 2 embodiments, wherein:
   the processing circuitry of the host is configured to execute a host application that receives the user data; and
   the host application is configured to interact with a client application executing on the UE, the client application being associated with the host application.
63. The host of the any of the previous 2 embodiments, wherein the initiating receipt of the user data comprises requesting the user data.
64. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
65. The method of the previous embodiment, further comprising at the network node, transmitting the received user data to the host.
66. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.
67. The host of the previous embodiment, wherein the cellular network further includes a network node configured to communicate with the UE to transmit the user data to the UE from the host.
68. The host of the previous 2 embodiments, wherein:
   the processing circuitry of the host is configured to execute a host application, thereby providing the user data; and
   the host application is configured to interact with a client application executing on the UE, the client application being associated with the host application.
69. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
70. The method of the previous embodiment, further comprising:
   at the host, executing a host application associated with a client application executing on the UE to receive the user data from the host application.
71. The method of the previous embodiment, further comprising:
   at the host, transmitting input data to the client application executing on the UE, the input data being provided by executing the host application,
   wherein the user data is provided by the client application in response to the input data from the host application.
72. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
73. The host of the previous embodiment, wherein the cellular network further includes a network node configured to communicate with the UE to transmit the user data from the UE to the host.
74. The host of the previous 2 embodiments, wherein:
   the processing circuitry of the host is configured to execute a host application, thereby providing the user data; and
   the host application is configured to interact with a client application executing on the UE, the client application being associated with the host application.
75. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
76. The method of the previous embodiment, further comprising:
   at the host, executing a host application associated with a client application executing on the UE to receive the user data from the UE.
77. The method of the previous 2 embodiments, further comprising:
   at the host, transmitting input data to the client application executing on the UE, the input data being provided by executing the host application,
      wherein the user data is provided by the client application in response to the input data from

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-43. (canceled)

44. A method in a User Equipment (UE) for configuring the UE to perform measurement reporting, the method comprising:
receiving a measurement reporting configuration, wherein the measurement reporting configuration is associated with a resource configuration, and the resource configuration is associated with one or more L1/L2-triggered mobility (LTM) candidate cells;
reporting one or more measurements performed on the one or more associated LTM candidate cells.

45. The method of claim 44, comprising determining, for the measurement reporting configuration, the one or more associated LTM candidate cells.

46. The method of claim 45, wherein determining the one or more associated LTM candidate cells comprises determining, from the measurement reporting configuration, an identifier of the associated resource configuration.

47. The method of claim 46, comprising determining, for the resource configuration, the one or more associated LTM candidate cells.

48. The method of claim 44, wherein reporting one or more measurements performed on the one or more associated LTM candidate cells comprises reporting one or more measurements performed for up to a predetermined maximum number of LTM candidate cells and/or up to a predetermined maximum number of synchronization signal blocks (SSBs) per LTM candidate cell.

49. The method of claim 44, comprising determining, for the measurement reporting configuration, one or more frequencies of the one or more associated LTM candidate cells.

50. The method of claim 49, wherein determining one or more frequencies comprises determining one or more synchronization signal block (SSB) frequencies.

51. The method of claim 44, wherein the measurement reporting configuration is received:
in a cell group configuration for the UE; and/or
in a RRC reconfiguration message.

52. The method of claim 44, comprising receiving the resource configuration.

53. The method of claim 44, wherein the measurement reporting configuration is received from a source distributed unit (S-DU).

54. The method of claim 44, wherein the measurement reporting configuration comprises a channel state information, CSI, reporting configurations.

55. The method of claim 44, wherein reporting, for the measurement reporting configuration, one or more measurements performed on the one or more associated LTM candidate cells comprises sending one or more measurement reports to a source distributed unit (S-DU).

56. The method of claim 44, wherein the measurement reporting configuration identifies one or more reference signal (RS) configurations for each LTM candidate cell.

57. The method of claim 56, wherein reporting one or more measurements performed on the one or more associated LTM candidate cells comprises reporting one or more measurements performed on a reference signal identified by one of the one or more RS configurations.

58. The method of claim 57, wherein the reference signal comprises a synchronization signal block (SSB).

59. A method performed by a first network node for configuring a User Equipment (UE) for measurement reporting, the method comprising:
sending, to the UE, a measurement reporting configuration, wherein the measurement reporting configuration is associated with a resource configuration, and the resource configuration is associated with one or more L1/L2-triggered mobility, LTM, candidate cells for the UE.

60. The method of claim 59, comprising receiving information from a central unit (CU), the information identifying the one or more LTM candidate cells for the UE.

61. The method of claim 59, wherein the measurement reporting configuration includes an identifier of the associated resource configuration.

62. A User Equipment (UE) configured for operation in a wireless communication network, the UE comprising:
a communication interface; and
processing circuitry operatively associated with the communication interface and, for measurement reporting by the UE, the processing circuitry is configured to:
receive a measurement reporting configuration via the communication interface, wherein the measurement reporting configuration is associated with a resource configuration, and the resource configuration is associated with one or more L1/L2-triggered mobility (LTM) candidate cells;
report, via the communication interface, one or more measurements performed on the one or more associated LTM candidate cells.

63. A network node configured for operation in a wireless communication network, the first network node comprising:
a communication interface; and
processing circuitry and configured to send a measurement reporting configuration to a User Equipment (UE), the measurement reporting configuration sent via the communication interface;
wherein the measurement reporting configuration is associated with a resource configuration, and the resource configuration is associated with one or more L1/L2-triggered mobility (LTM) candidate cells for the UE.
